(19) United States
(12) Patent Application Publication
(10) Pub. No.: US 2025/0232633 A1
(43) Pub. Date: Jul. 17, 2025

(54) ALTERNATIVE TOUCHSCREEN METHODS AND DETECTION

(71) Applicant: IGT, Las Vegas, NV (US)

(72) Inventors: Patrick Danielson, Las Vegas, NV (US); Jason Ingles, North Las Vegas, NV (US); Sean Miller, Henderson, NV (US)

(21) Appl. No.: 18/413,379

(22) Filed: Jan. 16, 2024

(51) Int. Cl. G07F 17/32; G06F 3/041

(52) U.S. Cl. CPC G07F 17/3209; G06F 3/0418; G07F 17/3234

(57) ABSTRACT

Embodiments of the present disclosure are directed to switching to alternative input methods in response to detection of malfunctioning one or more areas of a touchscreen input device. According to one embodiment, a method for providing alternative input to a system can comprise providing a display on a touchscreen of the system, detecting an area of the touchscreen which is not functioning to receive touch input, and in response to detecting the area of the touchscreen which is not functioning to receive touch input, switching to an alternative input method to receive input in place of the area of the touchscreen which is not functioning to receive touch input.

### BACKGROUND

The present disclosure is generally directed to operating a system utilizing a touchscreen input device and more particularly to switching to alternative input methods in response to detection of malfunctioning one or more areas of the touchscreen input device.

Touchscreen display devices are a common feature on many different types of computing systems and other electronic devices today. In many instances, old touchscreens and devices with damage on the touchscreen may impede the ability for a user to interact with the system or device. An example of this impedance is when a player inserts their player card into the card reader and interacts with the service window on the main display of a gaming system such as an Electronic Gaming Machine (EGM). If the touches are not aligned to the touchscreen, it is exceedingly difficult to complete simple entries such as menu selections and/or PIN code entry. Hance, there is a need in the art for methods and systems for detecting and dealing with such damage.

### BRIEF SUMMARY

Embodiments of the present disclosure are directed to switching to alternative input methods in response to detection of malfunctioning in one or more areas of a touchscreen input device. According to one embodiment, a method for providing alternative input to a system can comprise providing a display on a touchscreen of the system, detecting an area of the touchscreen which is not functioning to receive touch input, and in response to detecting the area of the touchscreen which is not functioning to receive touch input, switching to an alternative input method to receive input in place of the area of the touchscreen which is not functioning to receive touch input. In some cases, switching to the alternative input method to receive input in place of the area of the touchscreen which is not functioning to receive touch input can comprise prompting a user of the system to switch to the alternative input method.

Detecting the area of the touchscreen which is not functioning to receive touch input can comprise presenting, on the touchscreen, a test display having a plurality of touch points on the touchscreen and receiving, through the touchscreen, touch inputs based on the test display.

Detecting the area of the touchscreen which is not functioning to receive touch input is based on not receiving a touch input for one or the plurality of touch points. For example, the test display can be presented upon a user accessing the system. Additionally, or alternatively, detecting the area of the touchscreen which is not functioning to receive touch input can comprise detected a pattern of repeated touch inputs around the area of the touchscreen which is not functioning to receive touch inputs. Detecting the area of the touchscreen which is not functioning to receive touch input can additionally, or alternatively, comprise detecting a user access of the system, detecting a plurality of taps on the touchscreen, and detecting termination of the user access of the system. Additionally, or alternatively, detecting the area of the touchscreen which is not functioning to receive touch input can comprise detecting a swiping motion on an area of the touchscreen followed by a plurality of taps on the touchscreen.

According to another embodiment, a system can comprise a touchscreen display, a processor coupled with the touchscreen display, and a memory coupled with and readable by the processor. The memory can have stored therein a set of instructions which, when executed by the processor, causes the processor to provide a display on the touchscreen of the system, detect an area of the touchscreen which is not functioning to receive touch input, and in response to detecting the area of the touchscreen which is not functioning to receive touch input, switch to an alternative input method to receive input in place of the area of the touchscreen which is not functioning to receive touch input.

Switching to the alternative input method to receive input in place of the area of the touchscreen which is not functioning to receive touch input can comprise moving content displayed on the touchscreen to an area away from the area of the touchscreen which is not functioning to receive touch input. Additionally, or alternatively, switching to the alternative input method to receive input in place of the area of the touchscreen which is not functioning to receive touch input can comprise prompting a user to use a different type of input gesture or different area of the touchscreen to provide the touch input in place of the area of the touchscreen which is not functioning to receive touch input. Switching to the alternative input method to receive input in place of the area of the touchscreen which is not functioning to receive touch input can additionally, or alternatively, comprise receiving input from a mobile device of a user of the system instead of the touchscreen. Additionally, or alternatively, switching to the alternative input method to receive input in place of the area of the touchscreen which is not functioning to receive touch input can comprise receiving input from an augmented reality device of a user of the system instead of the touchscreen. Switching to the alternative input method to receive input in place of the area of the touchscreen which is not functioning to receive touch input can additionally, or alternatively, comprise receiving input from another input device of the system instead of the touchscreen.

According to yet another embodiment, an Electronic Gaming System (EGM) can comprise a touchscreen display, a processor coupled with the touchscreen display, and a memory coupled with and readable by the processor. The memory can have stored therein a set of instructions which, when executed by the processor, causes the processor to provide a display on the touchscreen of the system, detect an area of the touchscreen which is not functioning to receive touch input, and in response to detecting the area of the touchscreen which is not functioning to receive touch input, switch to an alternative input method to receive input in place of the area of the touchscreen which is not functioning to receive touch input. In some cases, the instructions can further cause the processor to provide a notification to an operator of the EGM indicating that the area of the touchscreen which is not functioning to receive touch input.

Switching to the alternative input method to receive input in place of the area of the touchscreen which is not functioning to receive touch input can comprise moving content displayed on the touchscreen to an area away from the area of the touchscreen which is not functioning to receive touch input. Additionally, or alternatively, switching to the alternative input method to receive input in place of the area of the touchscreen which is not functioning to receive touch input comprises prompting a user to use a different type of input gesture or different area of the touchscreen to provide the touch input in place of the area of the touchscreen which is not functioning to receive touch input. Switching to the alternative input method to receive input in place of the area of the touchscreen which is not functioning to receive touch input can additionally, or alternatively, comprise receiving input from a mobile device of a user of the system instead of the touchscreen. Additionally, or alternatively, switching to the alternative input method to receive input in place of the area of the touchscreen which is not functioning to receive touch input can comprise receiving input from an augmented reality device of a user of the system instead of the touchscreen. Switching to the alternative input method to receive input in place of the area of the touchscreen which is not functioning to receive touch input can additionally, or alternatively, comprise receiving input from another input device of the system instead of the touchscreen.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure can be implemented.

FIG. 2 is a block diagram illustrating additional details of components of an exemplary system in which embodiment of the present disclosure can be implemented.

FIG. 3 is a flowchart illustrating an exemplary process for providing alternative input to a system according to one embodiment of the present disclosure.

FIG. 4 is a flowchart illustrating additional details of an exemplary process for detecting an area of a touchscreen which is not functioning to receive touch input according to one embodiment of the present disclosure.

FIG. 5 is a flowchart illustrating additional details of an exemplary process for switching to an alternative input method according to one embodiment of the present disclosure.

### DETAILED DESCRIPTION

Embodiments of the present disclosure are directed to switching to alternative input methods in response to detection of malfunctioning in one or more areas of a touchscreen input device. Allowing alternative methods to interface and interact with the system may allow a user to bypass the damage or wear to the overlay with misalignment makes selecting virtual buttons and icons possible. Embodiments can use a variety of detection methods to identify potential touchscreen issues and notify the operator or other responsible entity to investigate the issue. Once detected, embodiments allow various input methods to allow alternative touchscreen interactions for the system to allow the touchscreen to continue to function and lessen the frustration of the overall user experience.

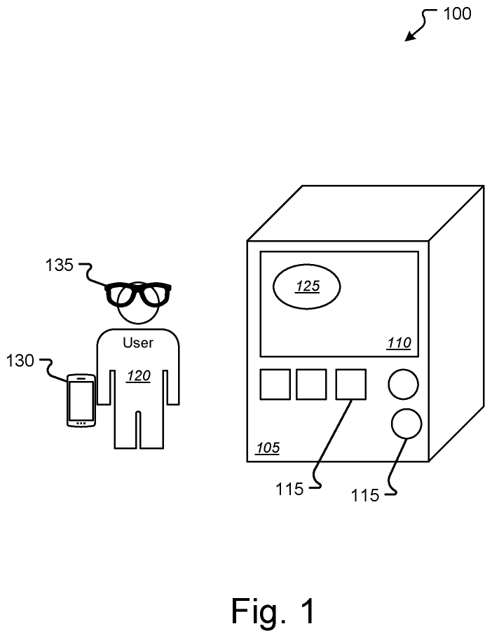

FIG. 1 is a block diagram illustrating an exemplary environment in which embodiments of the present disclosure can be implemented. As illustrated in this example, eh environment 100 can include a computing system 105 or other electronic device comprising a touchscreen 110 display used to provide touch inputs to the system 105 or device. For example, the system 105 can comprises a gaming system including, but not limited to an Electronic Gaming System (EGM). However, while examples are provided herein referencing an EGM or other gaming system, it should be noted that embodiments of the present disclosure are considered to be applicable to a wide range of different computing systems and electronic devices and are not limited to EGMs, gaming systems, or other particular devices. Rather, embodiments of the present invention are thought to be equally applicable to other devices including, but not limited to, mobile phones, tablets, laptop computers, various displays and/or monitors, or any device utilizing a touchscreen display as an input device. As illustrated here, the system 105 can also include other types of input devices 115 such as buttons, a mouse, a touchpad, a keyboard, etc. accessible by a user 120 to interact with the system 105. Generally speaking, embodiments of the present disclosure are directed to detecting one or more areas 125 of the touchscreen 110 that, due to damage, malfunction, or other reasons, have become inoperable and unable to receive touch input from the user 120.

A user 120 interreacting with a touchscreen 110 that is not operating correctly may be detectable by the system 105 by: detecting patterns of a temporary large area to allow a test on initial access of the system 105, e.g., card in if the system 105 is a gaming system; repeating patterns of touch that are detected to be in a scattered array around a particular screen area 125; access of the system, e.g., credits being applied to the gaming system with a card in, detection of quick tapping for a period of time, followed by termination of access, e.g., a cashout without any detectable game play; swiping motions in the service window area along with multiple fast taps; and/or others.

If such patterns of detection issues on the system 105 are recognized, the system 105 can trigger or prompt the user 120 to engage in alternative touchscreen entry methods. It should also be noted that it is possible for the system 105 to keep track of the possible detected area 125 and represent it for the on-screen touchscreen test when an expected touch path is out of bounds. According to one embodiment, the system 105 can also detect and notify the user 120 of a possible mis-touch as well by following paths and changing the presentation example follow paths. Also, it may be possible for the touchscreen test to display possible and probable touch area 125 issues prior to and following the test.

This process can be initiated as part of a touchscreen calibration procedure when the system 105 is installed and configured. The error data coordinates can be recorded and displayed on the touchscreen 110. The recorded error data can then be used for automated solutions described herein.

According to one embodiment, the user can enable alternative touchscreen entry with a selectable virtual button on the display of the touchscreen 110 via a special gesture (e.g., two or three fingers double tap), a physical button on the system 105, a pattern detected by a physical button on the system 105, e.g., double press service, a preference through a user tracking host system (not shown here), a connected mobile device application on the user's mobile device 130, or by the host by request.

According to one embodiment, when the system 105 detects an area 125 of the touchscreen 110 that is inoperable or unable to receive touch input and enters an alternative input mode, system 105 can notify an operator or other responsible entity of possible touchscreen issues on the system 105 to dispatch a technician to investigate the issue and determine possible damage. It should also be noted that if the touchscreen damage is prevalent enough, that the operator may indicate that damage is present and enable the alternative touchscreen entry mode as preferred by default until the damage has been repaired.

According to one embodiment, when the alternative input mode is activated, the content that specifically relates to the input required can be shifted vertically or horizontally to a sufficient distance away from the detect area 125 that that touches can be recorded. As an alternative to shifting selected content, the entire content can be shifted horizontally to a functioning area of the touch screen via alternative content and positioning, horizontal top or bottom positioning, or a combination thereof in a detectable “good” and functioning area of the touchscreen.

According to one embodiment, when the alternative input is activated, a virtual arrow on indicator can be displayed on the touchscreen that can be controlled by gesturing. In one embodiment, a player may be tapping multiple areas of the screen and, in response, the system 105 can prompt the player to ask if he or she is having an issue with the touchscreen 110. Instructions can be presented to enable the alternative input method. The instructions can indicate, for example, that tapping three times with two fingers or another predefined and recognizable pattern activates the alternative input. A selectable icon can be displayed that can be controlled by on-screen gestures. When the selectable icon is over the virtual button the player wants to activate, a single tap on anywhere on the screen can enable that selection.

According to one embodiment, the user's mobile device 130 can be used as the alternative input device. For example, using a mobile app, the user may report a touchscreen issue and also prompt the system 105 to allow the test to recognize and issue and to start an alternative input method. For example, the mobile device 130 can be used as a virtual trackpad to move a selectable icon around the display on the touchscreen 110. It should also be noted that the mobile device 130 can use either gestures or have an area of the mobile device 130 screen to move the selection icon and press the virtual buttons. The mobile device 130 can operate by connecting to the system 105 through WiFi, Near-Field Communication (NFC), BlueTooth, etc. For example, the player's mobile device 130 can connect to the gaming system and/or host system of the gaming venue through a player tracking system as known in the art. Inputs can be received through the mobile device 130 and such a player tracking system and can be provided to the gaming system.

According to another embodiment, the alternative input can utilize an augmented reality device 135 of the user 120 to detect gesture inputs. Additionally, or alternatively, physical buttons or other input devices 115 on the system could alternative input for the damaged touchscreen 125. For example, a user can tap a service button on the system 105 as indicated in the alternative entry patterns and the physical buttons 115 can be then highlighted that allow the selection icon to move around the screen and select and active virtual buttons on the display. In another embodiment, a virtual trackpad can be display to allow the selection icon to move the selection icon around and activate virtual buttons on the touchscreen.

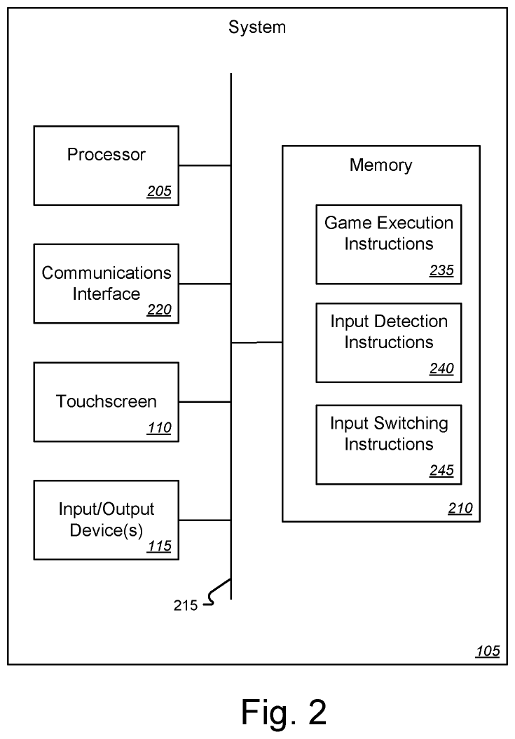

FIG. 2 is a block diagram illustrating additional details of components of an exemplary system in which embodiment of the present disclosure can be implemented. As illustrated in this example, a system 105 such as described above can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the game management system 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interface(s) 220, a touchscreen 110, and one or more other input/output devices 115 via the communications bus 215. The communication interface(s) 220 can comprise, for example, a Bluetooth, WiFi, cellular, and/or other type of wireless communications interface. Via the communication interface(s) 220, the game management system 105 can communication with gaming systems 115 and/or other devices and/or systems through a communications network 110 as described above. The touchscreen 110 can comprises a display device such as a Liquid Crystal Display (LCD), Light Emitting Diode (LED), Organic Light Emitting Diode (OLED), or other type of display having a touch-sensitive layer to detect touch inputs by a user 120 or the system 105. The input/output devices 115 can comprise any number and/or types of devices as known in the art including, but not limited to, buttons, a mouse, a keyboard, etc.

The memory 210 can store therein a set of instructions which, when executed by the processor 205, cause the processor 205 to perform any of a wide variety of functions depending upon the implementation of the system 105. For example, if the system 105 is a gaming system, EGM, or similar, the memory 210 can store therein a set of game execution instructions 235 which, when executed by the processor 205, cause the processor 205 to execute an electronic game and provide a display on the touchscreen 110 related to the electronic game. The electronic game can be any of a wide variety of electronic games of chance including, but not limited to, slots, video slots, video poker, keno, blackjack, etc. to be played by a player, e.g., in a casino or other gaming venue.

The memory 210 can also have stored therein a set of input detection instructions 240 which, when executed by the processor 205, causes the processor 205 detect an area 125 of the touchscreen 110 which is not functioning to receive touch input. Detecting the area 125 of the touchscreen 110 which is not functioning to receive touch input can be performed in one or more of a variety of ways. For example, detecting the area 125 of the touchscreen 110 which is not functioning to receive touch input can comprise presenting, on the touchscreen 110, a test display having a plurality of touch points on the touchscreen 110 and receiving, through the touchscreen 110, touch inputs based on the test display. Detecting the area 125 of the touchscreen 110 which is not functioning to receive touch input can be based on not receiving a touch input for one or the plurality of touch points. For example, the test display can be presented upon a user 120 accessing the system 105. Additionally, or alternatively, detecting the area 125 of the touchscreen 110 which is not functioning to receive touch input can comprise detected a pattern of repeated touch inputs around the area 125 of the touchscreen 110 which is not functioning to receive touch inputs. Detecting the area 125 of the touchscreen 110 which is not functioning to receive touch input can additionally, or alternatively, comprise detecting a user 120 access of the system 105, detecting a plurality of taps on the touchscreen 110, and detecting termination of the user 120 access of the system 225. Additionally, or alternatively, detecting the area 125 of the touchscreen 110 which is not functioning to receive touch input can comprise detecting a swiping motion on an area 125 of the touchscreen 110 followed by a plurality of taps on the touchscreen 110.

The memory 210 can also have stored therein a set of input switching instructions 245. In response to the input detection instructions 240 causing the processor 205 to detect the area 125 of the touchscreen 110 which is not functioning to receive touch input, the input switching instructions 245, when executed by the processor 205, can cause the processor 205 to switch to an alternative input method to receive input in place of the area 125 of the touchscreen 110 which is not functioning to receive touch input. In some cases, switching to the alternative input method to receive input in place of the area 125 of the touchscreen 110 which is not functioning to receive touch input can comprise prompting, through the touchscreen 110, a user 120 of the system 105 to switch to the alternative input method. Switching to the alternative input method to receive input in place of the area 125 of the touchscreen 110 which is not functioning to receive touch input can additionally, or alternatively, comprise moving content displayed on the touchscreen 110 to an area away from the area 125 of the touchscreen 110 which is not functioning to receive touch input. Additionally, or alternatively, switching to the alternative input method to receive input in place of the area 125 of the touchscreen 110 which is not functioning to receive touch input can comprise prompting, through the touchscreen 110, a user 120 to use a different type of input gesture or different area of the touchscreen 110 to provide the touch input in place of the area 125 of the touchscreen 110 which is not functioning to receive touch input. Switching to the alternative input method to receive input in place of the area 125 of the touchscreen 110 which is not functioning to receive touch input can additionally, or alternatively, comprise receiving, through the communications interface(s) 220, input from a mobile device 130 of a user 120 of the system 105 instead of the touchscreen 110. Additionally, or alternatively, switching to the alternative input method to receive input in place of the area 125 of the touchscreen 110 which is not functioning to receive touch input can comprise receiving, through the communications interface(s) 220, input from an augmented reality device 135 of a user 120 of the system 105 instead of the touchscreen 105. Switching to the alternative input method to receive input in place of the area 125 of the touchscreen 110 which is not functioning to receive touch input can additionally, or alternatively, comprise receiving input from another input device 115 of the system instead of the touchscreen 110.

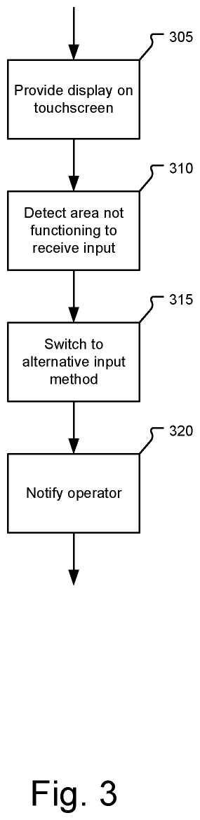

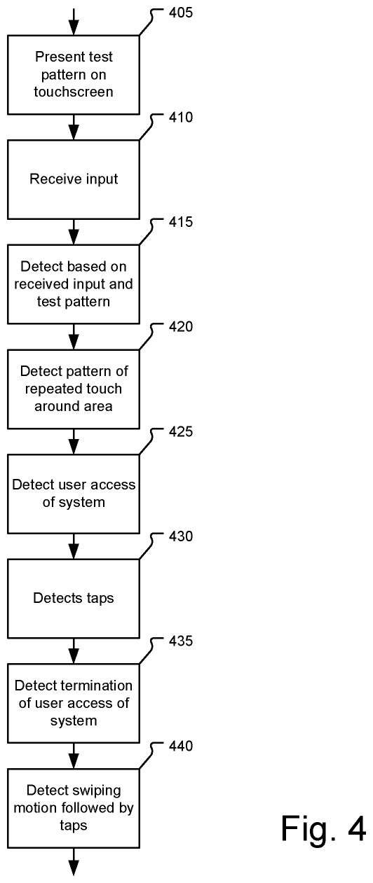

FIG. 3 is a flowchart illustrating an exemplary process for providing alternative input to a system according to one embodiment of the present disclosure. As illustrated in this example, the process can begin with providing 305 a display on a touchscreen 110 of the system 105 and detecting 310 an area 125 of the touchscreen 110 which is not functioning to receive touch input. Exemplary processes for detecting 310 an area 125 of the touchscreen 110 which is not functioning to receive touch input will be described in greater detail below with reference to FIG. 4.

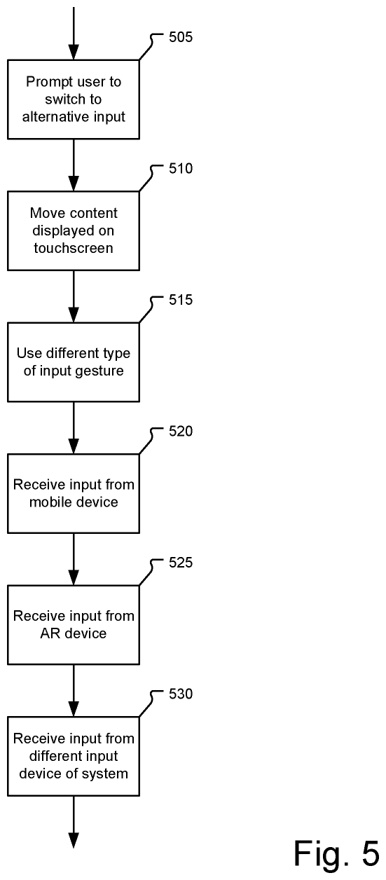

In response to detecting 310 the area 125 of the touchscreen 110 which is not functioning to receive touch input, the system 105 can switch 315 to an alternative input method to receive input in place of the area 125 of the touchscreen which is not functioning to receive touch input. Additional details of exemplary processes for switching to an alternative input method will be described below with reference to FIG. 5. In some cases, a notification can be provided 320 to an operator of the system indicating that the area 125 of the touchscreen 110 which is not functioning to receive touch input.

FIG. 4 is a flowchart illustrating additional details of an exemplary process for detecting an area 125 of a touchscreen which is not functioning to receive touch input according to one embodiment of the present disclosure. More specifically, this example illustrates various ways in which malfunctioning areas of the touchscreen 110 can be detected. It should be understood that any one, some, or all of these processes can be performed individually or together, and in various orders. As illustrated in this example, detecting the area 125 of the touchscreen 110 which is not functioning to receive touch input can comprise presenting 405, on the touchscreen 110, a test display having a plurality of touch points on the touchscreen and receiving 410, through the touchscreen 110, touch inputs based on the test display. Detecting 415 the area 125 of the touchscreen 110 which is not functioning to receive touch input is based on not receiving a touch input for one or the plurality of touch points. For example, the test display can be presented upon a user 120 accessing the system. Additionally, or alternatively, detecting the area 125 of the touchscreen 110 which is not functioning to receive touch input can comprise detected 420 a pattern of repeated touch inputs, e.g., repeated taps or swipes, around the area 125 of the touchscreen which is not functioning to receive touch inputs. Detecting the area 125 of the touchscreen 110 which is not functioning to receive touch input can additionally, or alternatively, comprise detecting 425 a user 120 access of the system 105, detecting 430 a plurality of taps on the touchscreen 110, and detecting 435 termination of the user 120 access of the system 105, e.g., within a predefined period of time. Additionally, or alternatively, detecting the area 125 of the touchscreen 110 which is not functioning to receive touch input can comprise detecting 440 a swiping motion on an area of the touchscreen followed by a plurality of taps on the touchscreen.

FIG. 5 is a flowchart illustrating additional details of an exemplary process for switching to an alternative input method according to one embodiment of the present disclosure. More specifically, this example illustrates various ways of switching to an alternative input method. It should be understood that any one, some, or all of these processes can be performed individually or together, and in various orders. In some cases, switching to the alternative input method to receive input in place of the area 125 of the touchscreen 110 which is not functioning to receive touch input can comprise prompting 505 a user 120 of the system to switch to the alternative input method. Switching to the alternative input method to receive input in place of the area 125 of the touchscreen 110 which is not functioning to receive touch input can additionally, or alternatively, comprise moving 510 content displayed on the touchscreen 110 to an area 125 away from the area 125 of the touchscreen 110 which is not functioning to receive touch input. Additionally, or alternatively, switching to the alternative input method to receive input in place of the area 125 of the touchscreen 110 which is not functioning to receive touch input can comprise prompting a user 120 to use 515 a different type of input gesture or different area of the touchscreen 515 to provide the touch input in place of the area 125 of the touchscreen 110 which is not functioning to receive touch input. Switching to the alternative input method to receive input in place of the area 125 of the touchscreen 110 which is not functioning to receive touch input can additionally, or alternatively, comprise receiving 520 input from a mobile device 130 of a user 120 of the system instead of the touchscreen 110. Additionally, or alternatively, switching to the alternative input method to receive input in place of the area 125 of the touchscreen 110 which is not functioning to receive touch input can comprise receiving 525 input from an augmented reality device 135 of a user 120 of the system instead of the touchscreen 110. For example, this input can comprise a gesture input. In other cases, and depending upon the capabilities of the augmented reality device 135, the input can be based on eye tracking and gaze detection of the player. Switching to the alternative input method to receive input in place of the area 125 of the touchscreen 110 which is not functioning to receive touch input can additionally, or alternatively, comprise receiving input from another input device 115, e.g., a button, mouse, keyboard, etc., of the system instead of the touchscreen 110. For example, and in some cases, the input device 115 can comprise a camera of the gaming system and the input can be based on eye tracking and gaze detection of the player.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PUP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for providing alternative input to a system, the method comprising:
providing, by a processor of the system, a display on a touchscreen of the system;
detecting, by the processor of the system, an area of the touchscreen which is not functioning to receive touch input; and
in response to detecting the area of the touchscreen which is not functioning to receive touch input, switching, by the processor of the system, to an alternative input method to receive input in place of the area of the touchscreen which is not functioning to receive touch input.

2. The method of claim 1, wherein detecting the area of the touchscreen which is not functioning to receive touch input comprises:
presenting, on the touchscreen, a test display having a plurality of touch points on the touchscreen; and
receiving, through the touchscreen, touch inputs based on the test display, wherein detecting the area of the touchscreen which is not functioning to receive touch input is based on not receiving a touch input for one or the plurality of touch points.

3. The method of claim 2, wherein the test display is presented upon a user accessing the system.

4. The method of claim 1, wherein detecting the area of the touchscreen which is not functioning to receive touch input comprises detected a pattern of repeated touch inputs around the area of the touchscreen which is not functioning to receive touch inputs.

5. The method of claim 1, wherein detecting the area of the touchscreen which is not functioning to receive touch input comprises:
detecting a user access of the system;
detecting a plurality of taps on the touchscreen; and
detecting termination of the user access of the system.

6. The method of claim 1, wherein detecting the area of the touchscreen which is not functioning to receive touch input comprises detecting a swiping motion on an area of the touchscreen followed by a plurality of taps on the touchscreen.

7. The method of claim 1, wherein switching to the alternative input method to receive input in place of the area of the touchscreen which is not functioning to receive touch input further comprises prompting a user of the system to switch to the alternative input method.

8. A system comprising:
a touchscreen display;
a processor coupled with the touchscreen display; and
a memory coupled with and readable by the processor and having stored therein a set of instructions which, when executed by the processor, causes the processor to:
provide a display on the touchscreen of the system;
detect an area of the touchscreen which is not functioning to receive touch input; and
in response to detecting the area of the touchscreen which is not functioning to receive touch input, switch to an alternative input method to receive input in place of the area of the touchscreen which is not functioning to receive touch input.

9. The system of claim 8, wherein switching to the alternative input method to receive input in place of the area of the touchscreen which is not functioning to receive touch input comprises moving content displayed on the touchscreen to an area away from the area of the touchscreen which is not functioning to receive touch input.

10. The system of claim 8, wherein switching to the alternative input method to receive input in place of the area of the touchscreen which is not functioning to receive touch input comprises prompting a user to use a different type of input gesture or different area of the touchscreen to provide the touch input in place of the area of the touchscreen which is not functioning to receive touch input.

11. The system of claim 8, wherein switching to the alternative input method to receive input in place of the area of the touchscreen which is not functioning to receive touch input comprises receiving input from a mobile device of a user of the system instead of the touchscreen.

12. The system of claim 8, wherein switching to the alternative input method to receive input in place of the area of the touchscreen which is not functioning to receive touch input comprises receiving input from an augmented reality device of a user of the system instead of the touchscreen.

13. The system of claim 8, wherein switching to the alternative input method to receive input in place of the area of the touchscreen which is not functioning to receive touch input comprises receiving input from another input device of the system instead of the touchscreen.

14. An Electronic Gaming System (EGM) comprising:
a touchscreen display;
a processor coupled with the touchscreen display; and
a memory coupled with and readable by the processor and having stored therein a set of instructions which, when executed by the processor, causes the processor to:
provide a display on the touchscreen of the system;
detect an area of the touchscreen which is not functioning to receive touch input; and
in response to detecting the area of the touchscreen which is not functioning to receive touch input, switch to an alternative input method to receive input in place of the area of the touchscreen which is not functioning to receive touch input.

15. The EGM of claim 14, wherein switching to the alternative input method to receive input in place of the area of the touchscreen which is not functioning to receive touch input comprises moving content displayed on the touchscreen to an area away from the area of the touchscreen which is not functioning to receive touch input.

16. The EGM of claim 14, wherein switching to the alternative input method to receive input in place of the area of the touchscreen which is not functioning to receive touch input comprises prompting a user to use a different type of input gesture or different area of the touchscreen to provide the touch input in place of the area of the touchscreen which is not functioning to receive touch input.

17. The EGM of claim 14, wherein switching to the alternative input method to receive input in place of the area of the touchscreen which is not functioning to receive touch input comprises receiving input from a mobile device of a user of the system instead of the touchscreen.

18. The EGM of claim 14, wherein switching to the alternative input method to receive input in place of the area of the touchscreen which is not functioning to receive touch input comprises receiving input from an augmented reality device of a user of the system instead of the touchscreen.

19. The EGM of claim 14, wherein switching to the alternative input method to receive input in place of the area of the touchscreen which is not functioning to receive touch input comprises receiving input from another input device of the system instead of the touchscreen.

20. The EGM of claim 14, wherein the instructions further cause the processor to provide a notification to an operator of the EGM indicating that the area of the touchscreen which is not functioning to receive touch input.
